(19) United States
(12) Patent Application Publication
(10) Pub. No.: US 2019/0306939 A1
(43) Pub. Date: Oct. 3, 2019

(54) CIRCUIT MODULE, CIRCUIT ARRANGEMENT, LIGHT SOURCE AND METHOD FOR SYNCHRONIZING DRIVING OF AT LEAST TWO ELECTRICAL DEVICES

(71) Applicant: OSRAM GmbH, Munich (DE)

(72) Inventor: Sebastian JOOSS, Dettingen (DE)

(21) Appl. No.: 16/364,201

(22) Filed: Mar. 26, 2019

(30) Foreign Application Priority Data
Mar. 28, 2018 (DE) 10 2018 204 771.5

(51) Int. Cl. H05B 33/08; B60Q 1/04; B60Q 1/46; B60Q 1/34

(52) U.S. Cl. CPC H05B 33/0809; H05B 33/0884; B60Q 1/04; F21V 29/74; B60Q 1/34; H05B 33/0824; B60Q 1/46

(57) ABSTRACT

A circuit module for synchronizing the driving of an electrical device module with a second electrical device of a second circuit module is provided. The module includes the electrical device designed to assume a first and a second state, a control unit for controlling the electrical device, wherein the control unit is designed to provide a control signal, depending on which control signal the electrical device changes from the first state to the second state, and a trigger line coupled to the control unit, via which the control unit is couplable to the second control unit of the second circuit module. A synchronization signal is providable at the second control unit by the control unit via the trigger line, which synchronization signal is correlated with the control signal for initiating at least one change of the electrical device from the first to the second state.

### CROSS-REFERENCE TO RELATED APPLICATION

This application claims priority to German Patent Application Serial No. 10 2018 204 771.5, which was filed Mar. 28, 2018, and is incorporated herein by reference in its entirety.

### TECHNICAL FIELD

Various embodiments relate generally to a circuit module for synchronizing a driving of at least one electrical device of the circuit module with at least one second electrical device of a second circuit module. In this case, the circuit module includes the at least one electrical device designed to assume a first state and a second state different than the first state, and also a control unit for controlling the at least one electrical device, wherein the control unit is designed to provide a control signal at an output of the control unit, depending on which control signal the at least one electrical device changes from the first state to the second state. Various embodiments also relate generally to a circuit module arrangement including a plurality of circuit modules, a light source, e.g. for a motor vehicle, and also a method for synchronizing a driving of at least one electrical device of a circuit module with at least one second electrical device of a second circuit module. The at least one electrical device can constitute for example an LED, that is to say a light emitting diode.

### BACKGROUND

The prior art comprehensively discloses circuit modules for driving electrical device, such as LEDs, for example, and so there is no need for separate documentary evidence of this. They usually serve to provide light for lighting purposes. Light emitting diodes are increasing being used as illuminants in order to be able to set a wide variety of lighting scenarios in a highly flexible manner, to be able to provide light in an energy-saving manner, and/or the like. In the meantime there has been a significant spread in the use of light emitting diodes as illuminants in luminaire devices and light sources, thus also giving rise to new fields of application for lighting devices based on light emitting diodes, inter alia also in the area of replacement of existing illuminants and light sources based, for example, on incandescent lamps, gas discharge lamps or the like. A light emitting diode, in particular also in association with the present invention, can be an LED but also a laser diode. In both cases, these can be directly emissive or be provided with a light converter, for example a phosphor, which converts light of a shorter wavelength into light of a longer wavelength.

The use of light sources based on light emitting diodes proves to be particularly advantageous in particular in the case of vehicles, particularly in the case of motor vehicles. It is precisely here that the advantage of generating light with high efficiency is manifested, wherein a predefined light emission can be achieved with little expenditure of electrical energy.

In order to be able to achieve a predefined luminous flux, with the use of light emitting diodes it is often customary to operate a plurality of light emitting diodes jointly, which can be arranged for example in the manner of a matrix. The light emitting diodes can be connected in series, for example, for the light emission as intended and a predefined light emitting diode current can be applied to said light emitting diodes. As a result, the light emission can be achieved in a predefined manner.

The light emitting diode current is generally a direct current that flows jointly through the light emitting diodes respectively connected in series. As a result, the same light emitting diode current is applied to each of the light emitting diodes connected in series, such that a substantially identical light emission can be achieved. The light emitting diode current is a direct current which, if appropriate, can also be clocked for the purpose of setting the luminous flux, for example in accordance with a pulse width modulation (PWM), or the like.

In order to be able to achieve a largely uniform light emission by means of the light emitting diodes connected in series, the light emitting diode current is generally provided by means of a current source unit that provides a predefined, preferably constant, light emitting diode current. Within a predefined voltage range in which the current source unit can provide the light emitting diode current substantially in a predefined manner, a likewise substantially uniform light emission can thus be achieved. For this purpose, the current source unit is moreover likewise connected in series with the light emitting diodes connected in series. The series circuits formed as a result have the electrical supply voltage applied to them overall by an electrical energy source, whereby the required electrical energy is provided.

Light emitting diodes furthermore also allow particularly flexible driving possibilities that can be used not only particularly advantageously for standard light functions of a motor vehicle, such as, for example, parking light, high beam, low beam, fog light, etc., but also for example for signal luminaires, for example for police cars, ambulances, fire department and the like.

It would be particularly advantageous, moreover, if individual LED modules could additionally be combined flexibly in any desired manner. In this regard, for example, more or fewer of such modules could be used for a light source, depending on the required size or desired illuminance of the light source. However, such a modular configuration leads to problems even exactly in the case of signal light applications.

Providing such a signal light necessitates switching light emitting diodes on and off alternately. In this case, synchronously switching series-connected light emitting diodes on and off is unproblematic and can readily be carried out simultaneously. However, if a plurality of individual modules having respective light emitting diodes and respective control units are installed in a signal luminaire, then a corresponding synchronization among these modules is required. Hitherto, however, this has been possible only to an inadequate degree or with very high outlay.

### SUMMARY

A circuit module for synchronizing the driving of an electrical device module with a second electrical device of a second circuit module is provided. The module includes the electrical device designed to assume a first and a second state, a control unit for controlling the electrical device, wherein the control unit is designed to provide a control signal, depending on which control signal the electrical device changes from the first state to the second state, and a trigger line coupled to the control unit, via which the control unit is couplable to the second control unit of the second circuit module. A synchronization signal is providable at the second control unit by the control unit via the trigger line, which synchronization signal is correlated with the control signal for initiating at least one change of the electrical device from the first to the second state.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a schematic illustration of a circuit module including a trigger line for synchronization with other circuit modules in accordance with one embodiment;

FIG. 2 shows a schematic illustration of a circuit module arrangement including a plurality of circuit modules, the control units of which are connected in parallel via a common trigger line, in accordance with one embodiment;

FIG. 3 shows a schematic illustration of a circuit module including a trigger line for synchronization with further circuit modules and an additional predictive circuit in accordance with a further embodiment;

FIG. 4 shows a schematic and perspective illustration of a light source including a mounting base, in accordance with one embodiment; and

FIG. 5 shows a schematic and perspective illustration of a printed circuit board of the light source from FIG. 4.

### DESCRIPTION

The following detailed description refers to the accompanying drawings that show, by way of illustration, specific details and embodiments in which the invention may be practiced.

In the embodiments, the described components of the embodiments in each case constitute individual features of the invention which are to be considered independently of one another and which in each case also develop the invention independently of one another and should thus also be regarded as part of the invention individually or in a different combination than that shown. Furthermore, the embodiments described are also supplementable by further features of the invention from among those already described.

In the figures, functionally identical elements are provided in each case with the same reference signs.

Various embodiments provide a circuit module, a circuit module arrangement, a light source and a method for synchronizing a driving of at least one electrical device with at least one second electrical device of a second circuit module which enable synchronization in as simple and cost-effective a manner as possible.

A circuit module according to various embodiments for synchronizing a driving of at least one electrical device of the circuit module with at least one second electrical device of a second circuit module in this case includes the at least one electrical device designed to assume a first state and a second state different than the first. Furthermore, the circuit module includes a control unit for controlling the at least one electrical device. In this case, the control unit is designed to provide a control signal at an output of the control unit, depending on which control signal the at least one electrical device changes from the first state to the second state. Furthermore, the circuit module includes a trigger line coupled to the control unit, via which trigger line the control unit is couplable to a second control unit of the second circuit module, wherein a synchronization signal is providable at the second control unit by the control unit via the trigger line, which synchronization signal is correlated with the control signal for initiating at least one change of the electrical device from the first to the second state.

As a result, it may be possible for a plurality of circuit modules to synchronize themselves via the common trigger line. This may be achieved by virtue of the fact that the synchronization signal provided via the trigger line is correlated with the control signal for initiating the change of the electrical device from the first to the second state. That is to say that if for example a plurality of such circuit modules are coupled to one another via the trigger line, then that circuit module which first initiates the change of the electrical device from the first to the second state communicates a corresponding synchronization signal to the remaining circuit modules, which in association therewith likewise initiate this change of the electrical device from the first to the second state. This type of self-synchronization has the effect that there is no need for a superordinate control unit for synchronizing the individual circuit modules. The circuitry outlay can thus be reduced to a minimum, which at the same time allows a particularly cost-effective configuration of the circuit module. In various embodiments, said self-synchronization can be realized particularly simply by providing a common trigger line via which the individual control units of the circuit modules are connectable in parallel with one another.

As mentioned in the introduction, the at least one electrical device, and also the at least one second electrical device, can be an LED, i.e. a light emitting diode. However, the principle of this self-synchronization of the individual circuit modules can also be applied to any other electrical devices for which a synchronization is advantageous and desired. By way of example, the at least one electrical device can also constitute a sensor, such that the invention and its configurations can likewise implement a synchronization of the detection by individual sensors assigned to respective circuit modules.

Furthermore, the circuit module may also include a plurality of electrical devices. The latter can be connected in series with one another, for example. Furthermore, the control unit for controlling the at least one electrical device can be configured for example as an electronic circuit, in particular as an integrated circuit.

This simple possibility for synchronization of a plurality of circuit modules enables particularly flexible arrangements in a particularly cost-effective manner. The arrangement possibilities of a plurality of electrical devices, such as a plurality of light emitting diodes, for example, are thus no longer restricted to the arrangement thereof within a circuit module, but rather can be configured in any desired manner by combining as many circuit modules as desired with one another. Consequently, by way of example, light sources including a plurality of such circuit modules can be fashioned in any desired sizes and shapes, and nevertheless provide a synchronization of the individual light emitting diodes of the different circuit modules in a particularly simple and cost-effective and also reliable manner.

In order to enable a mutual synchronization of individual circuit modules, it may be provided that the circuit module is designed not only to provide a synchronization signal correlated with the control signal at the second circuit module via the trigger line, but also to receive a corresponding synchronization signal from the second circuit module or else further circuit modules in a corresponding manner. Therefore, it constitutes a further configuration of various embodiments if a synchronization signal providable by the second control unit is applicable to an input of the control unit via the trigger line, wherein the control unit is coupled to the trigger line in such a way that applying the synchronization signal initiates the outputting of the control signal for initiating the at least one change of the electrical device from the first to the second state.

That is to say that if the control unit correspondingly receives a corresponding synchronization signal from a different circuit module via the trigger line, then the control unit of the circuit module also automatically initiates the change of the at least one electrical device from the first to the second state.

A continuously synchronization of the individual circuit modules among one another is thus ensured during operation. Even small differences in the speed of the clock generators of the respective circuit modules or of the respective control units thus cannot adversely affect the synchronized driving of the electrical devices. Even temperature- and tolerance-dictated temporal deviations between the driving of the individual electrical devices of the respective circuit modules can thus advantageously be eliminated. In other words, that circuit module with currently the fastest clock also triggers all the other circuit modules that are connected to the common trigger line.

In a further configuration of various embodiments, the control unit is designed to provide a control signal such that a repeated, alternating change between the first and second states takes place in accordance with at least one predetermined change pattern.

Precisely in applications in which a frequent change between the first and second states of the electrical device takes place, for example during flashing operation of light emitting diodes, a synchronization may be provided since it is precisely here that small temporal deviations have a particularly serious consequence. If the electrical device is therefore a light emitting diode, for example, then the change pattern can constitute a flashing pattern, for example. The at least one light emitting diode can be switched on and off in a defined manner for example by means of driving by the control unit, for example with a specific frequency. It is precisely in applications as an emergency signal luminaire, warning signal luminaire or the like that frequencies in the range of between 1 Hz and 10 Hz are provided, e.g. between 1 Hz and 2 Hz. In this case, the on and off periods, that is to say the durations of the first and second states, need not necessarily be of equal length. This generally means that the at least one electrical device can also be in the first and second states for time durations of different lengths. By way of example, an on period can be configured to be shorter than an off period, or vice versa.

In this case, it can for example also be provided that the control unit is designed to store a plurality of different predetermined change patterns. This enables a particularly high degree of flexibility and a particularly good situation adaptation since a suitable flashing signal can thus be implemented depending on the situation, for example. In this regard, it is possible to store different operating modes in accordance with the different change patterns and to implement them as necessary. Moreover, the change frequency at which a change is made between the first and second states can also be adjustable, e.g. continuously adjustable. This, too, in turn enables many adaptation possibilities. The control unit can moreover also receive input signals from various other signal sources, e.g. external signal sources, in order, depending on said input signals, to initiate a flashing sequence or generally a change sequence, to end said sequence, to select a change pattern from a plurality of stored change patterns and/or to set the change frequency. Such external signal sources can constitute for example an external detection device for detecting an emergency or a fault case within the motor vehicle in which the circuit module finds application, or a signal or warning light which is provided by a police car and which was detected by means of a camera of the motor vehicle in which the circuit module finds application, or other external signals which can be received for example by means of WLAN, Bluetooth, lidar, radar, radio, etc.

In a further configuration of various embodiments, the trigger line is coupled to the control unit via a protective circuit, wherein the protective circuit is designed for defined voltage limiting and/or noise suppression. It is thus possible to suppress voltage spikes, to avoid overvoltages and overcurrents and/or to improve the signal-to-noise ratio. By way of example, it is possible to use one or more diodes and/or Zener diodes and/or resistors for voltage limiting and for avoiding voltage spikes in the protective circuit. Furthermore, it is also possible to use one or more capacitors for signal smoothing and/or noise suppression. In various embodiments, the trigger line can also be coupled to an input of the control unit via a resistor, which limits the input current in the case of an overvoltage. For further increased robustness, a PTC (Positive Temperature Coefficient) thermistor and/or a resettable fuse can additionally also be arranged in series with the trigger input.

In a further configuration of various embodiments, the control signal for transferring the electrical device from the first state to the second state constitutes an active low signal. This can be implemented particularly simply in terms of circuitry. In various embodiments, this enables a further configuration of various embodiments in which the output of the control unit constitutes an open-collector output. The output of the control unit for driving the electrical device is thus realized with the aid of a transistor whose collector remains open, that is to say unconnected. The emitter of this output transistor is connected to ground. In this regard, as a result of a high potential at the base of the transistor, the output signal of the control unit can be pulled to ground. By contrast, in the case of a low potential at the base, the output signal is pulled to the operating voltage by a suitable pull-up resistor. As a result, it is thus possible, in a simple manner, to provide a suitable control signal at the output in order to control or switch on and off the current flow through the at least one electrical device. In various embodiments, for this purpose, the control output of the control unit can be connected to a gate of a MOSFET (metal oxide semiconductor field effect transistor), for example a p-channel MOSFET, the drain terminal of which is connected to ground and the source terminal of which is connected to the operating voltage via the at least one electrical device. The tap of the pull-up resistor mentioned above can then be situated between the control output of the control unit and the base terminal of the MOSFET.

In the same way, as an alternative to an open-collector output, the output of the control unit for driving the at least one electrical device can also be realized as a tristate output.

Furthermore, it may be provided that a falling signal edge of the control signal provides the synchronization signal for edge-triggered synchronization on the trigger line. If a plurality of control unit of a plurality of different circuit modules are thus connected in parallel with one another via the trigger line, then that control unit which is the first to change to the low state thus pulls all the other control units likewise to the low state, which is triggered by the falling signal edge of the control signal. The transition from the first to the second state thus takes place synchronously in all coupled circuit modules.

In a further configuration of various embodiments, the at least one electrical device constitutes an LED, i.e. a light emitting diode. As already described in the introduction, precisely for light emitting diodes there are a multiplicity of useful and applications, precisely in the area of providing warning and flashing signals, such as, for example, in the case of ambulances, police cars, fire-fighting vehicles, rescue drones or rescue robots.

If the at least one electrical device thus constitutes a light emitting diode, then the first state constitutes a state in which the at least one LED does not emit light, and the second state constitutes a state in which the LED emits light. The same also holds true if the circuit module includes not just a single light emitting diode, but for example a plurality of light emitting diodes connected in series. Precisely with regard to warning signal luminaires, it may be provided that if the at least one light emitting diode is furthermore configured as a blue light emitting diode. The embodiments and its configurations thus make it possible to provide any desired light emitting diode configurations and flashing patterns which enable synchronized flashing.

In the same way, the circuit module according to various embodiments or its configurations can, however, also be used to operate other electrical devices in a synchronized manner, such as sensors, for example. No limits are imposed here on the application possibilities. Moreover, various embodiments and its configurations can be used for example for flashlight control for smartphones and/or cameras.

In a further configuration of various embodiments, the circuit module includes a controllable current source unit connected in series with the at least one electrical device and serving for applying a predefinable electric current to the at least one electrical device. The current source unit can be realized for example as an electronic circuit that predefines a predefinable current, for example the light emitting diode current, over a specific operating voltage range. Said current can be provided substantially as a constant current within the operating voltage range. For this purpose, it is possible to use suitable electronic circuits, for example using operational amplifiers or the like. However, transistor circuits including a regulation function for the purpose of providing the predefined current may be suitable. In this regard, by way of example, the current to be set can be realized by means of a current sensor, for example in the form of a resistor at which a corresponding electrical voltage is tapped off, the sensor signal of which, being the electrical voltage across the resistor in the last-mentioned case, is used for setting the current. The current itself may be set by means of a transistor, e.g. by means of a MOSFET. The sensor signal of the current sensor is used for providing a control signal for the transistor. The provision of the control signal can encompass further electronic components, inter alia also one or more further transistors, in order to be able to make possible a predefinable regulation function. At the same time, the regulation function also makes possible an adjustability of the current, for example of the light emitting diode current.

As already described, the output of the control unit can be coupled to said current source unit, e.g. to the gate of the MOSFET, in order thereby to control the current through the at least one electrical device and, as a result, to switch the electrical device on and off or generally to transfer it from the first to the second state, and vice versa.

Moreover, the supply voltage for supplying the control unit can be provided for example very simply by a Zener diode and a resistor.

Furthermore, various embodiments also relate to a circuit module arrangement including a plurality of circuit modules according to various embodiments or their configurations. Furthermore, the respective control units of the circuit modules are connected in parallel with one another via the common trigger line. As a result, a self-synchronization of the driving of the respective at least one electrical device may be provided, without the need for a superordinate control device.

In various embodiments, in this case, the respective control units of the circuit modules are connected in parallel via the common trigger line in such a way that that control unit with currently the fastest clock provides the synchronization signal on the trigger line.

In this case, the effects described for the circuit modules according to various embodiments and their configurations are applicable in the same way to the circuit module arrangement according to various embodiments and its configurations.

The individual control units, e.g. if more than two control units of corresponding circuit modules are connected in parallel with one another via the trigger line, can in this case be interconnected with one another in accordance with a star-shaped or serial topology via the trigger line.

Furthermore, various embodiments also relate to a light source, e.g. for a motor vehicle, including a circuit module arrangement according to various embodiments or one of its configurations. Here, too, the effects mentioned for the circuit modules according to various embodiments and its configurations are applicable in the same way to the light source according to various embodiments.

The light source, e.g. for a motor vehicle, can be configured in this case for example as a warning luminaire, a flashing light or else as a headlight. Nevertheless, various embodiments also make it possible, however, to provide light sources for other applications, for example for drones, smartphones, cameras or the like.

Furthermore, various embodiments relate to a method for synchronizing driving of at least one electrical device of a circuit module with at least one second electrical device of a second circuit module, wherein the circuit module includes the at least one electrical device designed to assume a first state and a second state different than the first. Furthermore, the circuit module also includes a control unit for controlling the at least one electrical device, wherein the control unit is designed to provide a control signal at an output of the control unit, depending on which control signal the at least one electrical device changes from the first state to the second state. In this case, the circuit module furthermore includes a trigger line coupled to the control unit, via which trigger line the control unit is couplable to a second control unit of the second circuit module, wherein a synchronization signal is provided at the second control unit by the control unit via the trigger line, which synchronization signal is correlated with the control signal for initiating at least one change of the electrical device from the first to the second state.

The effects mentioned for the circuit modules according to various embodiments and its configurations are also applicable in the same way to the method according to various embodiments. Furthermore, the substantive features mentioned in association with the circuit module according to various embodiments and its configurations enable the development of the method according to various embodiments by further corresponding method steps.

Furthermore, various embodiments also encompasses the combinations of the embodiments described.

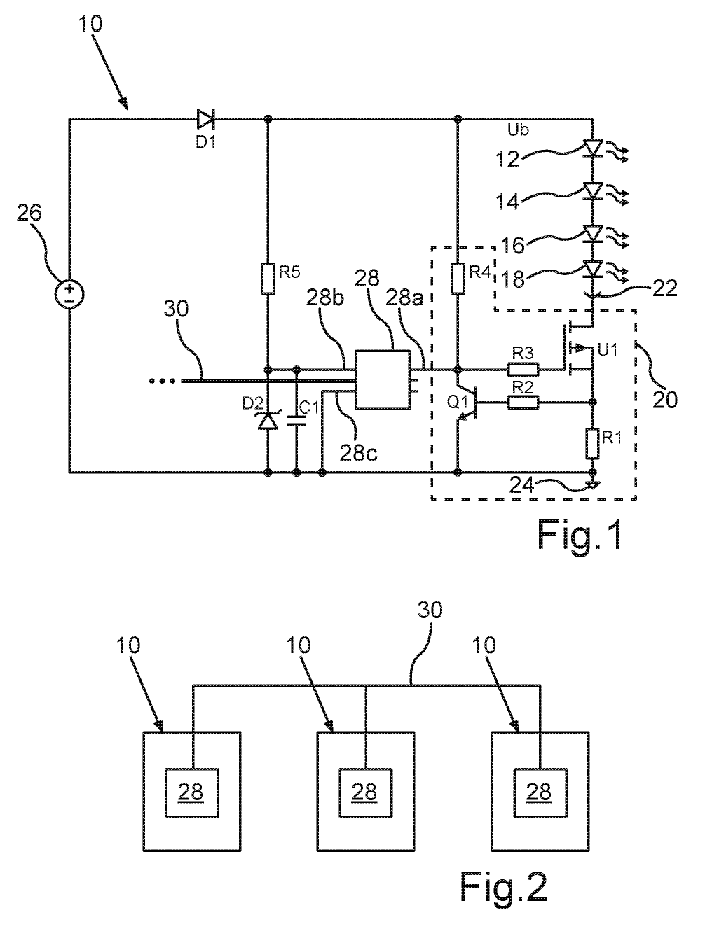

FIG. 1 shows a schematic illustration of a circuit module 10, which in this example is configured as a light module including a plurality of series-connected LEDs 12, 14, 16, 18 as the at least one electrical device. Furthermore, a current source unit 20 is connected in series with the light emitting diodes 12, 14, 16, 18 in order to apply a predefinable electric light emitting diode current 22 to the series-connected light emitting diodes 12, 14, 16, 18.

In the present case, the current source unit 20 has a resistor R1, through which the light emitting diode current 22 flows and which serves for detecting the light emitting diode current 22. Accordingly, a voltage signal is provided as light emitting diode current signal, which is used for regulating the light emitting diode current 22 and for this purpose is fed to a bipolar transistor Q1 at the base thereof via a resistor R2. As a result, the conductivity of the transistor Q1 is controlled depending on the light emitting diode current signal.

An emitter of the transistor Q1 is electrically coupled to a reference potential 24, which is also referred to as ground. A collector of the transistor Q1 is connected via a resistor, e.g. at the pull-up resistor R4, to a positive electrical potential of the supply voltage Ub provided by a voltage source 26. The supply voltage Ub is determined with respect to the reference potential 24. The reference potential 24 thus provides a negative electrical potential of the supply voltage Ub.

Furthermore, in the present case, the supply voltage Ub is fed via a diode D1 of the circuit module 10 in order to avoid polarity reversal.

Furthermore, a first terminal of a resistor R3 is connected to the collector of the transistor Q1, the second terminal of said resistor being connected to a gate of a MOSFET U1. The MOSFET U1 is likewise assigned to the current source unit 20 and serves for setting the light emitting diode current 22. A regulating circuit is formed as a result. The function of this regulating circuit is evident to the person skilled in the art on the basis of the circuit structure and basically does not require further explanations. With the current source unit 20, the light emitting diode current 22 can be kept substantially constant within a predefined operating voltage range substantially independently of a voltage drop at the current source unit 20. The current to be set can be set e.g. by means of a resistance value of the electrical resistor R1.

As soon as the operating voltage Ub is thus applied to the series-connected LEDs 12, 14, 16, 18 the current source unit 20 begins to adjust a constant light emitting diode current 22 through the LEDs 12, 14, 16, 18.

In order to provide a flashing sequence or a predetermined flashing pattern, the circuit module 10 furthermore includes a control unit 28, which can be configured for example as an integrated circuit. In this case, an output 28a of the control unit is coupled to the gate of the MOSFET U1 via the resistor R3. Depending on the control signal provided at the output 28a of the control unit 28, it is thus possible to switch on and off the current flow through the LEDs 12, 14, 16, 18 and thus the LEDs 12, 14, 16, 18 themselves.

The supply voltage for the control unit 28 can be provided in a simple manner by a Zener diode D2 and a resistor R5, or alternatively by any other supply circuit desired. In this case, the resistor R5 and the Zener diode D2 are arranged in a series connection between the supply voltage Ub and the reference potential 24, wherein a tap between the resistor R5 and the Zener diode D2 is fed to an input 28b of the control unit 28. Furthermore, a further input 28c of the control unit 28 is connected to the reference potential 24. Furthermore, a capacitor C1 for smoothing and improving the signal-to-noise ratio can also be connected in parallel with the Zener diode D2.

By means of the control unit 28, different flashing patterns or flashing sequences can also be stored, and be implemented by means of a suitable control signal depending on the situation.

The output 28a of the control unit 28 is preferably an open-collector output or a tristate output.

In order then to be able to operate a plurality of such circuit modules 10 in a synchronized manner, a trigger line 30 is then provided. By means of said trigger line 30, the respective control units 28 of respective circuit modules 10 may then be connected in parallel with one another, as is illustrated schematically in FIG. 2.

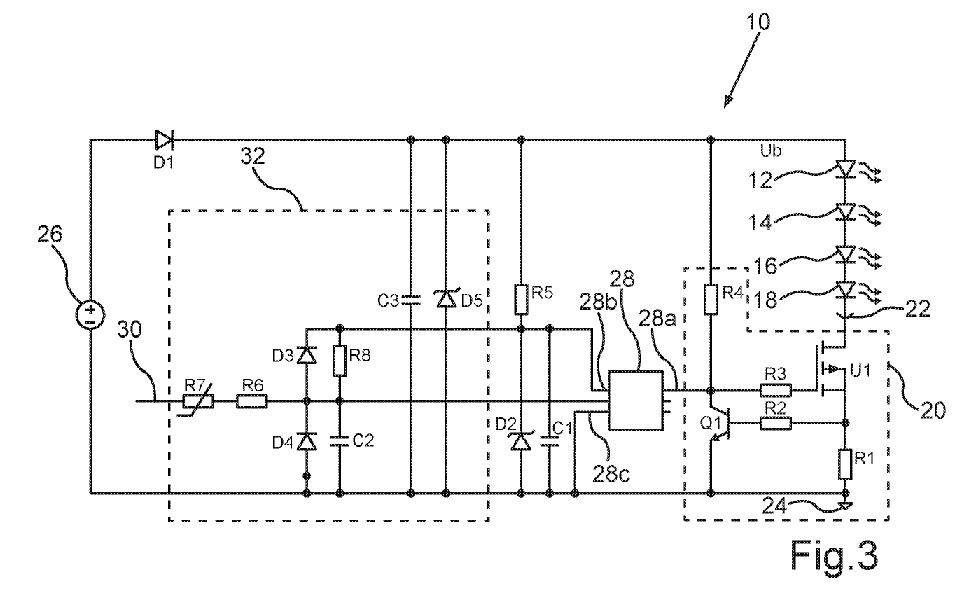

In this case, FIG. 2 shows a schematic illustration of a plurality of circuit modules 10, each of which can be configured as described with regard to FIG. 1, or else as will also be described with regard to FIG. 3. In each case only the corresponding control unit 28 is illustrated for a respective circuit module 10 here, for reasons of clarity. The control units 28 of the respective circuit modules 10 are thus connected in parallel with one another via a common trigger line 30. The interconnection by means of the common trigger line can have in this case a star topology or chain topology.

The synchronization signal (reset) provided via said trigger line constitutes an active low signal that is correlated with the output signal obtained from the control signal at the output 28a. The trigger pulses of said synchronization signal are correlated e.g. with the falling edge of the control signal. Said trigger line 30 thus makes it possible to avoid temporal deviations during driving on account of tolerances and temperature effects.

In other words, that circuit module 10 with the fastest clock also triggers all other circuit modules 10 that are connected to the common trigger line 30, as a result of which a synchronous flashing sequence of the respective LEDs 12, 14, 16, 18 of the respective circuit modules 10 can be provided and a temporal divergence of the pulses can be avoided.

In the case where the trigger line 30 is not connected, the respective circuit modules from among the circuit modules 10 trigger themselves, which can likewise be useful, for example if there is no need for synchronization or if only a single circuit module 10 is used. Consequently, the circuit modules 10, in a simple manner, can be arbitrarily combined with one another or used individually, wherein, if a synchronization between the individual circuit modules 10 is desired, the latter can be connected to one another via the common trigger line 30 in a simple manner.

Furthermore, it is advantageous if the trigger line 30 is coupled to the control unit 28 via a protective circuit 32, which is illustrated schematically in FIG. 3.

FIG. 3 shows here, for example, once again a circuit module 10 configured as a light module, which circuit module can be configured as described with regard to FIG. 1, apart from the differences described below.

In this case, the trigger line 30 is now coupled to the control unit 28 via a protective circuit 32, which has further resistors R6, R8, diodes D3, D4, a further Zener diode D5, and further capacitors C2, C3. The capacitor C3 and the Zener diode are respectively connected in parallel with the series connection of the LEDs 12, 14, 16, 18 and the current source unit 20. An overvoltage at the control unit 28 can be avoided by means of the diodes D2 and D3, and a negative voltage can be avoided by means of the diode D4. By means of the capacitor C2, voltage spikes can be avoided and noise that could lead to an incorrect trigger can be suppressed or reduced. The resistor R6 serves for limiting the input current in the case of an overvoltage. In addition, a PTC thermistor and/or a resettable fuse R7 can also be additionally connected in series with the trigger input of the control unit 28.

This constitutes only one example of a possible protective circuit 32. Numerous other measures for voltage limiting and/or noise suppression are also conceivable.

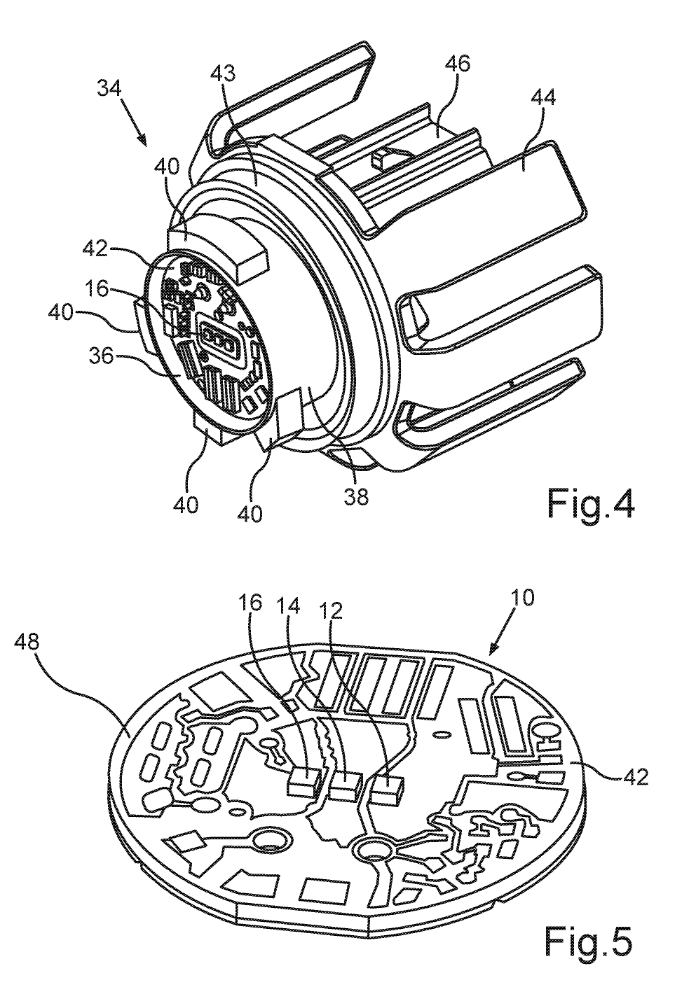

FIG. 4 shows, in a schematic perspective illustration, a light source 34 including a mounting base 36, which light source can be used for example as a light source for the described light module of a motor vehicle. The light source 34 has a mounting base 36, via which the light source 34 can be secured to a mount (not illustrated in any further detail). The mounting base 36 has an approximately circular-cylindrical outer lateral surface 38, from which four key lugs 40 extend radially outward. At the end side, the mounting base 36 has a circular-cylindrical cutout, in which is arranged a printed circuit board 42 on which the circuit module 10 is realized.

At a distance from the key lugs 40, the mounting base 36 is enveloped by a sealing ring 43.

Furthermore, a heat sink 44 extends from the mounting base 36. Said heat sink has a plurality of cooling ribs extending axially away from the mounting base 36 in a direction opposite to that in which light is emitted by the circuit module 10. In this case, the cooling ribs surround a terminal 46 for the light source 34, said terminal being provided for the electrical contacting.

FIG. 5 shows a schematic perspective illustration of the printed circuit board 42 of the light source 34 in accordance with FIG. 4. A circuit module 10 in accordance with one example of various embodiments is realized on the printed circuit board 42. In this example, the circuit module includes by way of example only three LEDs 12, 14, 16. The printed circuit board 42 includes, as populating side, a first printed circuit board surface 48 and, on the opposite side, a second printed circuit board surface, which is not illustrated in any further detail in the present case. On the printed circuit board top side (top layer) provided by the first printed circuit board surface 48, further electronic components (not illustrated) are thus mounted alongside the light emitting diodes 12, 14, 16.

### LIST OF REFERENCE SIGNS

10 Circuit module
12 Light emitting diode
14 Light emitting diode
16 Light emitting diode
18 Light emitting diode
20 Current source unit
22 Light emitting diode current
24 Reference potential
26 Voltage source
28 Control unit
28a Output of the control unit
28b Input of the control unit
28c Input of the control unit
30 Trigger line
32 Protective circuit
34 Light source
36 Mounting base
38 Outer lateral surface
40 Key lugs
42 Printed circuit board
43 Sealing ring
44 Heat sink
46 Terminal
48 First printed circuit board surface
C1 Capacitor
C2 Capacitor
C3 Capacitor
D1 Diode
D2 Zener diode
D3 Diode
D4 Diode
D5 Zener diode
R1 Resistor
R2 Resistor
R3 Resistor
R4 Resistor
R5 Resistor
R6 Fuse
Ub Operating voltage
U1 MOSFET
Q1 Bipolar transistor

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A circuit module for synchronizing the driving of at least one electrical device of the circuit module with at least one second electrical device of a second circuit module, the circuit module comprising:
the at least one electrical device designed to assume a first state and a second state different than the first;
a control unit for controlling the at least one electrical device, wherein the control unit is designed to provide a control signal at an output of the control unit, depending on which control signal the at least one electrical device changes from the first state to the second state; and
a trigger line coupled to the control unit, via which trigger line the control unit is couplable to a second control unit of the second circuit module, wherein a synchronization signal is providable at the second control unit by the control unit via the trigger line, which synchronization signal is correlated with the control signal for initiating at least one change of the electrical device from the first to the second state.

2. The circuit module of claim 1,
wherein a synchronization signal providable by the second control unit is applicable to an input of the control unit via the trigger line;
wherein the control unit is coupled to the trigger line in such a way that applying the synchronization signal initiates the outputting of the control signal for initiating the at least one change of the electrical device from the first to the second state.

3. The circuit module of claim 1,
wherein the control unit is designed to provide a control signal such that a repeated, alternating change between the first and second states takes place in accordance with at least one predetermined change pattern.

4. The circuit module of claim 1,
wherein the control unit is designed to store a plurality of different predetermined change patterns.

5. The circuit module of claim 1,
wherein the trigger line is coupled to the control unit via a protective circuit;
wherein the protective circuit is designed for defined at least one of voltage limiting or noise suppression.

6. The circuit module of claim 1,
wherein the control signal for transferring the electrical device from the first state to the second state constitutes an active low signal.

7. The circuit module of claim 1,
wherein the output of the control unit constitutes an open-collector output or a tristate output.

8. The circuit module of claim 1,
wherein a falling signal edge of the control signal provides the synchronization signal for edge-triggered synchronization on the trigger line.

9. The circuit module of claim 1,
wherein the at least one electrical device constitutes an LED.

10. The circuit module of claim 9,
wherein the first state constitutes a state in which the at least one light emitting diode does not emit light, and the second state constitutes a state in which the light emitting diode emits light.

11. The circuit module of claim 1, further comprising:
a controllable current source unit connected in series with the at least one electrical device and serving for applying a predefinable electric current to the at least one electrical device.

12. A circuit module arrangement, comprising:
a plurality of circuit modules, each circuit module comprising:
at least one electrical device designed to assume a first state and a second state different than the first;
a control unit for controlling the at least one electrical device, wherein the control unit is designed to provide a control signal at an output of the control unit, depending on which control signal the at least one electrical device changes from the first state to the second state; and
a trigger line coupled to the control unit, via which trigger line the control unit is couplable to a second control unit of the second circuit module, wherein a synchronization signal is providable at the second control unit by the control unit via the trigger line, which synchronization signal is correlated with the control signal for initiating at least one change of the electrical device from the first to the second state.

13. The circuit module arrangement of claim 12,
wherein the respective control units of the circuit modules are connected in parallel via the common trigger line in such a way that that control unit with currently the fastest clock provides the synchronization signal on the trigger line.

14. A light source, for example for a motor vehicle, the light source comprising:
a circuit module arrangement, comprising:
a plurality of circuit modules, each circuit module comprising:
at least one electrical device designed to assume a first state and a second state different than the first;
a control unit for controlling the at least one electrical device, wherein the control unit is designed to provide a control signal at an output of the control unit, depending on which control signal the at least one electrical device changes from the first state to the second state; and
a trigger line coupled to the control unit, via which trigger line the control unit is couplable to a second control unit of the second circuit module, wherein a synchronization signal is providable at the second control unit by the control unit via the trigger line, which synchronization signal is correlated with the control signal for initiating at least one change of the electrical device from the first to the second state.

15. A method for synchronizing the driving of at least one electrical device of a circuit module with at least one second electrical device of a second circuit module, the method comprising:
the at least one electrical device assuming a first state and a second state different than the first;
a control unit controlling the at least one electrical device, wherein the control unit provides a control signal at an output of the control unit, depending on which control signal the at least one electrical device changes from the first state to the second state; and
a trigger line coupled to the control unit, via which trigger line the control unit is couplable to a second control unit of the second circuit module, wherein a synchronization signal is provided at the second control unit by the control unit via the trigger line, which synchronization signal is correlated with the control signal for initiating at least one change of the electrical device from the first to the second state.
